(19) United States
(12) Patent Application Publication
(10) Pub. No.: US 2018/0051522 A1
(43) Pub. Date: Feb. 22, 2018

(54) SUCKER ROD TERMINUS ASSEMBLY FOR UNDERGROUND WELLS

(71) Applicant: LIFTING SOLUTIONS USA, INC., Irvine, CA (US)

(72) Inventors: ROB SJOSTEDT, IRVINE, CA (US); HUGH COOK, IRVINE, CA (US)

(73) Assignee: LIFTING SOLUTIONS, INC., IRVINE, CA (US)

(21) Appl. No.: 15/557,693

(22) PCT Filed: Mar. 11, 2016
(86) PCT No.: PCT/US2016/021951

§ 371 Date: Sep. 12, 2017

Related U.S. Application Data
(60) Provisional application No. 62/132,226, filed on Mar. 12, 2015.

(51) Int. Cl. E21B 17/04; B29C 70/16; B29C 70/48; B29C 70/84; F16B 7/02; F16G 11/04

(52) U.S. Cl. CPC E21B 17/04; B29C 70/16; B29C 70/48; B29K 2063/00; F16B 7/02; F16G 11/042; B29C 70/845

(57) ABSTRACT

A sucker rod terminus assembly is provided for use in downhole wells. The sucker rod terminus assembly includes a plurality of parallel composite strands forming an elongate rod and a metallic terminus fitting. The terminus fitting has a cavity with a proximal opening to receive the rod end. The cavity includes a plurality of frustum shaped chambers. Preferably, the frustum shaped chambers have different sizes or shapes wherein at least a frustum chamber's proximal end diameter, distal end diameter, or length is different than an adjacent frustum chamber's proximal end diameter, distal end diameter, or length. Even more preferably, each frustum chamber is diametrically larger than the frustum chamber positioned proximally to it. Preferably, the sucker rod assembly further includes a spreader plate, preferably made up of a plurality of pieces and a hardened material to affix the rod to the terminus fitting.

### BACKGROUND OF THE INVENTION

The present invention relates generally to sucker rod engineering and design. More particularly, the present invention relates to a composite sucker rod assembly for use in downhole vertical lift oil extraction.

Sucker rods for use with vertical lift rod pumps, also referred to as surface units, rocking horse, or pump jacks are typically made from individual lengths of steel rod sections that are connected together by threaded couplings. A typical sucker rod string is from 700 to 10,000 feet or more in length. The sucker rod string connects the vertical lift surface device to the downhole pump unit.

Current steel sucker rods are typically ¾ inch diameter, ⅞ inch diameter, 1 inch diameter, or 1 and ⅛ inch diameter. The ends of the rods are formed to include a wrench location and machined threads to interface with couplings that join the individual rods together. The individual sucker rods are typically 25 feet, 30 feet or 37.5 feet in length and are connected together with couplings to form a sucker rod string. A string of segmented sucker rods is connected between the vertical lift pumping unit at the surface and the downhole pump at or near the bottom of the oil well. Shorter rods often called “Pony Rods” are used to fine tune the overall length of the sucker rod string and the position of the pump downhole. Sinker Bars (larger diameter heavy rods) are used at the bottom of the well to weight the entire string for the down stroke. The sucker rods reciprocate up and down in a tube that is typically steel and suspended in the wellbore or casing.

Steel sucker rods are stiff and since no well is perfectly straight, sucker rods often cause excessive wear on the inside of the well casing where the well is not straight. Additionally, the flex in the string induced by pumping causes metal fatigue which can cause the sucker rod to fail particularly at the threaded connections or due to stress corrosion cracking. The highly corrosive environment worsens the frequency of rod failures. An unexpected broken sucker rod is expensive to remove and replace. Further, the weight of a metal sucker rod string limits its strength and fatigue life and can limit the depth which even large surface units can pump. The weight of a steel sucker rod string can also overload and reduce the life of the surface unit and its components.

In an effort to overcome some of these disadvantages, monolithic fiberglass sucker rods have been developed. The fiberglass rods have steel-end fittings bonded over the outside surface of each end of the monolithic fiberglass rod. Fiberglass sucker rods do offer a weight reduction and corrosion resistance, but have a lower tensile modulus than steel and therefore suffer significant stretch. Further, fiberglass sucker rods have been known to suffer premature failure if subjected to any compression loading during the pumping cycle.

A carbon fiber composite sucker rod pultruded as a monolithic bar and meeting the typical requirements of a sucker rod would not be attractive because it would be subject to compression failures similar to fiberglass and it would be difficult to make the terminus end fitting match the strength potential of the carbon fiber composite mid-section since it would be merely glued on the outside of the monolithic rod versus tying into the majority of the fibers.

A continuous length steel sucker rod is also used in a small but increasing percentage of oil wells. Steel continuous length sucker rods require large diameter spools and special handling techniques. Continuous steel sucker rods are limited in the length that can be practically used due to weight, transportation and handling issues. Continuous length steel sucker rods are heavy, corrode, and are subject to fatigue failure.

Composite tension members made with a plurality of continuous carbon fiber elements, aramid fiber, fiberglass or other high strength fiber elements with a resin matrix offer attractive performance features such as lightweight, high tensile strength and corrosion resistance compared to traditional metallic tension members. Composite tension members are used in civil engineering structures, architectural structures, sailboat standing rigging for masts, downhole sucker rods and numerous other applications. In many cases, the terminus end fittings attached to the composite tension members are metal components having a conical shaped frustum within that forms a mechanical connection between the terminus and the plurality of composite tension member elements. The metallic end fitting usually has screw threads, clevis pins or some means for attachment to another component. Examples of a terminus of this type are evidenced in various teachings such as U.S. Pat. No. 3,672,712 and U.S. Pat. No. 7,137,617. Both of these patents describe composite tension members made of a plurality of parallel strands that flare out within the metal terminus and are embedded in a polymer wedge that mechanically holds the terminus and the tension member together.

While the conical terminus has been a successful means to create an end fitting for a composite tension member, it has a basic problem due to a localized stress concentration at the nose of the fitting where the composite rods enter the terminus and where the cast polymer frustum that holds the terminus begins. This stress concentration reduces the strength of the overall tension member assembly. A properly made composite tension member with all the fibers equal in length and thereby equally loaded is prone to breaking just inside the terminus when loaded to its ultimate strength value partly as a result of a localized stress concentration. It is the combination of tensile load on the strands plus the localized radial compressive load due to displacement of the conical wedge that causes the strands to fail below the ultimate strength of the fiber strands or before they pull out of the terminus fitting. The stress concentration is created by axial displacement of the polymer wedge within the terminus end fitting under load.

The conical angle and the elastic properties of the wedge determine the amount of displacement under load. If the polymer wedge is not adhesively bonded to the terminus, the conical angle is low, and if the coefficient of friction between the cone and the terminus is low, there will be significant displacement of the cone within the terminus as a tensile load is applied to the member. This displacement results in a tri-axial stress concentration just inside the small end of the conical terminus. Even if the cone is bonded to the terminus, or if the coefficient of friction is high between the cone and the terminus, there is displacement by virtue of the polymer distorting under a high tensile load. This stress concentration reduces the overall strength of the tension member. While the wedge effect of the conical fitting is beneficial from the standpoint of mechanically holding the terminus on to the tension member and amplifying the lap shear strength of the strands embedded in the polymer frustum, it contributes to a lower strength value for the assembly. A typical conical shaped terminus for composite tension members achieves only about 60-80% of the strength potential of the composite strands due to the stress concentration at the nose of the terminus under ideal conditions.

Certain hot/wet environmental use conditions, such as those downhole sucker rods experience, further reduce the overall tensile strength of the member due to plasticizing effects to the strength element matrix resin and the frustum polymer thereby reducing the transverse modulus of the strands and the frustum polymer which increases the displacement of the frustum within the terminus fitting and increases the localized stress concentration. In some cases, a carbon fiber tension member subjected long term to very harsh hot/wet conditions can have a 50% reduction in strength compared to the same tension member in a dry and room temperature condition. This reduction in overall strength is not due to any hot/wet degradation of the fiber itself but due to the combined effects of reduction in transverse mechanical properties for the strands and the frustum plus lubrication of the terminus fitting and the frustum interface, resulting in increased displacement and greater localized stress concentration. Even a slight reduction in the bulk modulus of the composite strands and the frustum can dramatically reduce the overall strength of the tension member assembly. Since it is not possible to prevent the plasticizing effects of hot/wet conditions on typical polymers such as epoxy, it would be very desirable to reduce the stress concentration or the effect thereof at the terminus fitting which would result in a higher strength tension member both in dry and hot/wet conditions. U.S. Pat. No. 5,713,169 offers one solution to the problem by tailoring the elastic modulus of the polymer cone. Unfortunately, this approach is difficult to manufacture and offers only a partial solution to the effects of a hot/wet environment.

Accordingly, it would be desirable to provide a sucker rod assembly that can meet or exceed all operational requirements and offer significant weight reduction, corrosion resistance, deeper pumping capability, less maintenance, longer life and overall improved oil production economics, thus having pumping performance and service life advantages over previous sucker rods.

Moreover if would be desirable to provide solutions to the stress concentration problem inherent with conical wedge terminations for continuous fiber composite tension members made with a plurality of strands.

### SUMMARY OF THE INVENTION

The present invention addresses the aforementioned disadvantages by providing an improved sucker rod terminus assembly for use in downhole vertical lift oil extraction.

The sucker rod terminus assembly comprises a plurality of composite strands to create a light weight, corrosion and fatigue resistant sucker rod assembly. Preferably, the strands are made of carbon fiber, and will be described primarily as employing carbon fiber. However, other composite materials may be employed, and the invention is not intended to be limited to carbon fiber.

In a preferred embodiment, the sucker rod assembly strands are made of carbon fiber manufactured by the pultrusion process or variation thereof wherein high strength fibers are drawn through a resin bath to impregnate the fibers, and then drawn through heated dies and/or ovens to shape, consolidate and cure the strands into generally round or polygonal cross-sections such as hexagons or octagons. Preferably, the fiber fraction of the strands is optimized for tensile strength, stiffness, durability and handling. Additionally, the plurality of the strands that make up the sucker rod assembly should be straight and equal in length in order to maximize the overall strength of the sucker rod assembly.

In a preferred embodiment, the high strength carbon fibers within a polymer matrix are bundled together in parallel to form an elongate rod. Furthermore, altering the number of strands allows for tailoring the mechanical properties of the sucker rod assembly and the sucker rod string. A larger bundle of strands is used for the sucker rods at the top of the well (near the surface) since the upper sucker rods must carry the weight of the entire sucker rod string. A smaller bundle of strands is used for the sucker rods near the bottom of the well since the tensile stress is lower, although the weight of the lifted oil must also be taken into account. The overall sucker rod string is configured to meet strength and longitudinal stiffness requirements and optimize pumping efficiency. A carbon fiber sucker rod assembly of this configuration has been demonstrated to be approximately one-fifth the weight of steel sucker rods while retaining comparable strength.

The sucker rod assembly includes a terminus fitting at one end of the rod, and preferably at both ends of the rod. Preferably, the terminus fittings are made of metal such as a high carbon steel. However, other metals or materials may be employed. Each terminus fitting has a proximal end, a distal end, and a central cavity which extends to the terminus fitting's proximal end to form a proximal opening for receipt of the elongate rod into the cavity. In some embodiments, the terminus fitting's cavity flares outwardly from the fitting's proximal end toward said fitting's distal end to form a conical shape. In alternative embodiments, the cavity includes a plurality of frusto-conically (also referred to herein as “frustum”) shaped chambers. Preferably, the frustum shaped chambers have different sizes or shapes wherein at least a frustum chamber's proximal end diameter, distal end diameter, or length is different than an adjacent frustum chamber's proximal end diameter, distal end diameter, or length. Even more preferably, each frustum chamber is diametrically larger than the frustum chamber positioned proximally to it.

In a preferred embodiment, the terminus fitting's central cavity extends from the fitting's proximal opening to the terminus fitting's distal end to form a distal opening. The distal opening may include a female thread for affixing to a male threaded member.

The elongate rod's plurality of strands are splayed-out within the terminus fitting's cavity and encapsulated with a polymer resin, ceramic material, metal material, or combination thereof, which hardens to form a wedge in the shape of the cavity. Once hardened into the wedge, the wedge affixes the terminus fitting to the plurality of strands.

The polymer material for the terminus wedge can be epoxy, phenolic or other thermosetting resin meeting the performance requirements. For extremely deep wells, a heat resistant ceramic or metal material may be used for the terminus wedge. A preferred method for assembling the carbon fiber sucker rod assembly is to inject the polymer or ceramic material directly into the terminus fitting. The terminus polymer or ceramic wedge is cast by injecting the material into a port which projects through the side of the terminus fitting. Preferably, the terminus fitting has two ports used for the wedge material injection. One port is an injection port to inject the polymer or ceramic into the fitting. The other port is a vent hole which provides a temporary vent and a sight window to show that adhesive resin has filled the tapered or multiple frustum shaped cavity. Preferably, the polymer or ceramic wedge material is injected into the terminus fitting while the terminus fitting is lying in a horizontal position.

Preferably, at least one spreader plate is positioned within the terminus fitting's cavity. The spreader plate is preferably planar and substantially round so as to define a central axis. Preferably, the spreader plate is positioned within the terminus fitting's central cavity with the spreader plate's central axis coincident with the cavity's central axis. Preferably, the spreader plate has a diameter slightly smaller than the diameter of the terminus fitting's cavity at the spreader plate's location within the central cavity. The spreader plate has a plurality of holes which receives the rod strands so as to splay out the strands in a widened orientation compared to where the strands enter the terminus fitting's proximal opening.

Preferably, the spreader plate is constructed of two or more pieces wherein each piece includes an engagement edge for engaging an engagement edge of an adjoining piece. The pieces may be held together to form a single spreader plate simply by the rod strands forcing the pieces radially together to engage one another. Also preferably, the engagement edges of the spreader plate pieces include one or more indents for engaging indents formed in the engagement edges of adjoining pieces so that adjoining indents of adjoining pieces form holes which receive the strands. In preferred embodiments, the spreader plate pieces also include a peripheral edge where the pieces do not engage an adjoining piece such as where the spreader plate periphery is adjacent to the terminus fitting's cavity wall. It is preferred that the peripheral edge of each piece include one or more indents for receiving and splaying out one or more strands in a widened orientation compared to where the strands pass through said terminus fitting's proximal opening.

In an alternative embodiment, an annular spacer is applied over the ends of each strand to maintain the strands in a splayed configuration within the terminus fitting while a polymer is injected into the fitting and cured. For this embodiment, it is preferred that the annular spacers are positioned longitudinally on the strands at approximately the same location so as to engage one another. Alternatively, the annular spacers may be longitudinally positioned at different locations so as to engage adjoining strands.

The sucker rod assembly includes a connection member for connecting to other sucker rod assemblies or other equipment. A preferred connection member has a male threaded end which affixes to the terminus fitting's female thread. Preferably, the connection member projects into the cavity sufficient such that the connection member engages the wedge to place the wedge in a state of compression. This construction places a pre-load on the wedge which enhances its ability to handle cyclic tension and compressive loads.

The preferred method to compress the wedge within the terminus fitting is to inject the polymer or ceramic material into the terminus with the threaded connection member backed out slightly from its final (not fully torqued) position. After the wedge is cured, the threaded connection member is fully screwed in place and torqued as appropriate. Another option is to use a dummy connection member when the polymer or ceramic wedge is injected into the fitting. This dummy connection member can be slightly shorter than the final connection member so a compressive load is applied to the wedge when the final connection member is installed.

A minimum number of strands are preferably bundled together to form a length of the sucker rod terminus assembly. The plurality of parallel strands may be fully over-wrapped with an encapsulating layer of composite or polymer material that holds the bundle together and provides a wear resistant covering. The over-wrap may also be spaced incrementally to keep the bundle together, thereby increasing the overall stiffness of the sucker rod assembly and providing tailored dampening for compressive loads. The bundle of strands is preferably held together with a composite wrap spaced incrementally sufficient to hold the bundle of rods together but allow them to flex between the wrap if the rod experiences a compressive load. The spacing and the length of the incremental composite wraps can be used to tailor the compressive stiffness of the overall carbon composite sucker rod assembly.

The plurality of parallel strands are preferably bundled in a generally polygonal or round package so the sucker rod assembly can be progressively rotated in a well tubing as typically done to prevent wear in one spot. It is also necessary for the strands to splay-out evenly in the terminus without crossing one strand over another.

Wear guides and paraffin scrapers may be installed along the length of the composite sucker rod assembly after it is assembled. Wear guides are typically used only on sucker rods running in a deviated portion of the oil well. A preferred method is to mold a fiber filled composite wear guide directly onto the bundle of strands. This can be accomplished by infusion molding a relatively thick three dimensional fiber mat that is wrapped around the strand's bundle. A two piece mold is clamped around the wrapped fiber form. Thermosetting epoxy is injected into the mold and flows through the porous spun polyester material. When cured, the mold is removed. The three dimensional spun polyester mat impregnated with epoxy forms a wear resistant composite particularly suited for application that is permanently bonded over the sucker rod. Advantageously, the wear guides can also function as wraps incrementally spaced to provide the desired compressive dampening and rod stiffness, as described above. A preferred method is to mold the composite wear guide over an incrementally spaced band in order to maintain the desired band spacing.

In another embodiment, woven fiberglass, carbon fiber or aramid fiber cloth tape can be convolutely wrapped with resin around the bundle of carbon fiber rods such that it functions both as a wear band and the banding that holds the plurality of rods together.

Other features and advantages of the present invention will be appreciated by those skilled in the art upon reading the detailed description which follows with reference to the attached drawings.

### BRIEF DESCRIPTION OF THE DRAWINGS

FIG. 1 is an exploded perspective view of a sucker rod assembly;

FIG. 2 is a side cut-away view of a sucker rod terminus assembly;

FIG. 3 is an exploded cut-away view of a sucker rod terminus assembly;

FIG. 4 is a side cut-away view of a sucker rod terminus assembly illustrating a first cavity configuration;

FIG. 5 is a side cut-away view of a sucker rod terminus assembly illustrating a second cavity configuration;

FIG. 6 is a side cut-away view of a sucker rod terminus assembly illustrating a third cavity configuration;

FIG. 7 is a side cut-away view of a sucker rod terminus assembly illustrating injection of resin into the cavity;

FIG. 8 is an exploded perspective view of a spreader plate;

FIG. 9 is a perspective view of a spreader plate;

FIG. 10 is a top view of a first spreader plate;

FIG. 11 is a top view of a second spreader plate;

FIG. 12 is a top view of a third spreader plate;

FIG. 13 is a top view of a fourth spreader plate;

FIG. 14 is a side view of a sucker rod terminus assembly including wear guides;

FIG. 15 is a side cut-away view of a sucker rod terminus fitting and connector member;

FIG. 16 is a side cut-away view of a sucker rod terminus assembly;

FIG. 17 is a side cut-away view of an additional embodiment of a sucker rod terminus assembly;

FIG. 18 is a side cut-away view of a sucker rod terminus assembly; and

FIG. 19 is a side cut-away view of a sucker rod terminus fitting.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

With reference to the figures, the sucker rod assembly 10 includes a plurality of strands 20 forming an elongate rod 15. The sucker rod assembly 10 further includes a terminus fitting 30 having a central cavity 33, a spreader plate 22, and preferably a connection member 45. A plurality of sucker rod assemblies are connected together to form a sucker rod string 11 to connect a vertical lift surface device to a downhole pump unit.

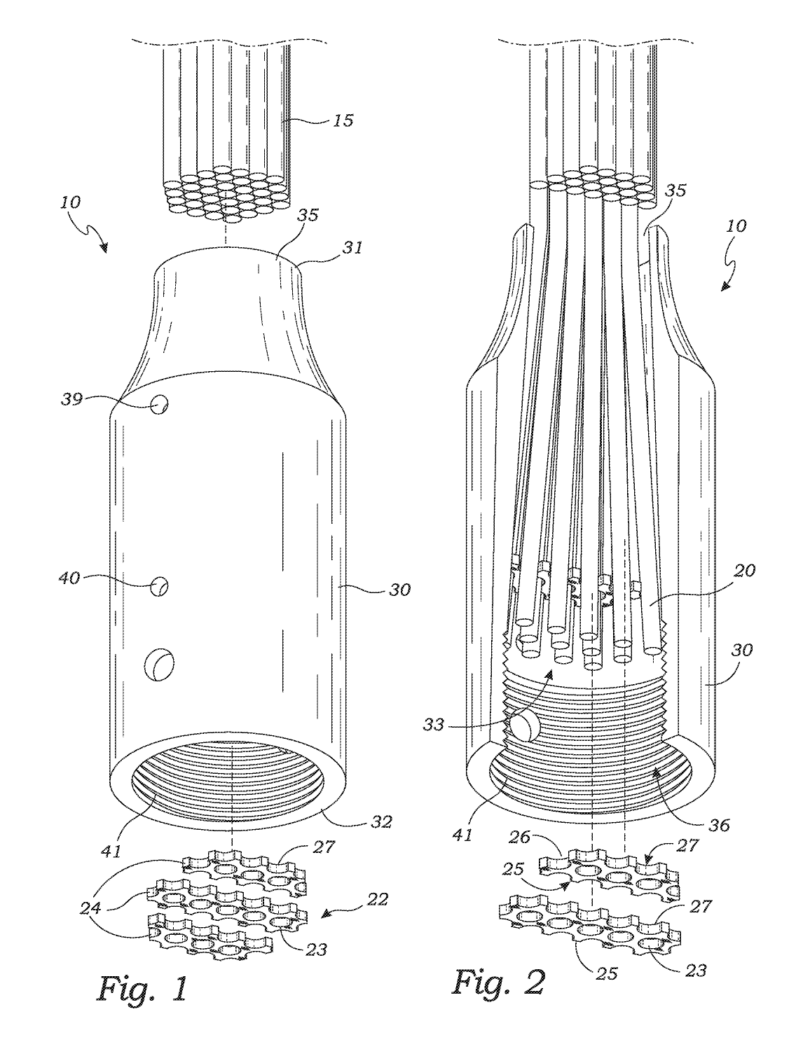

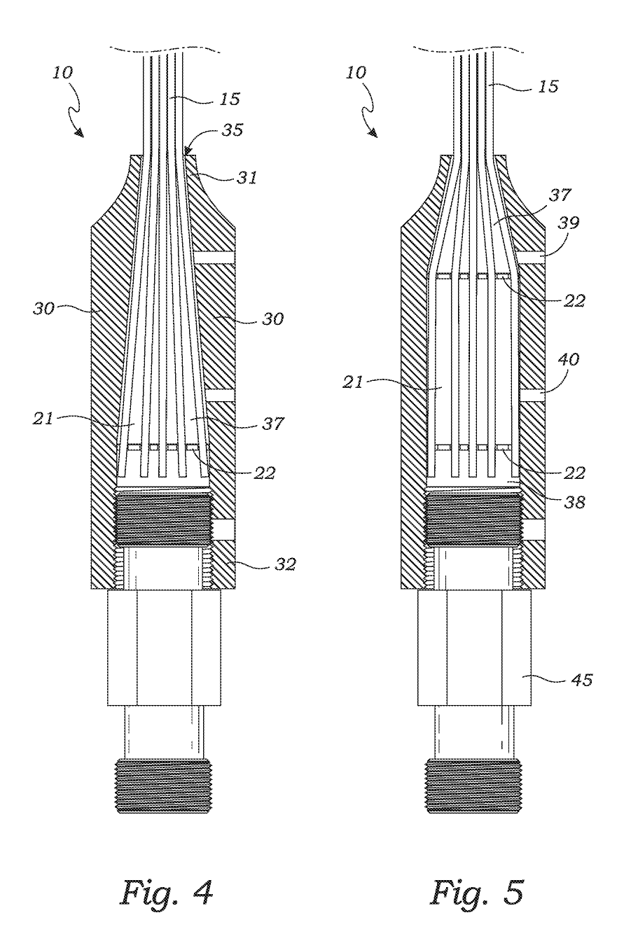

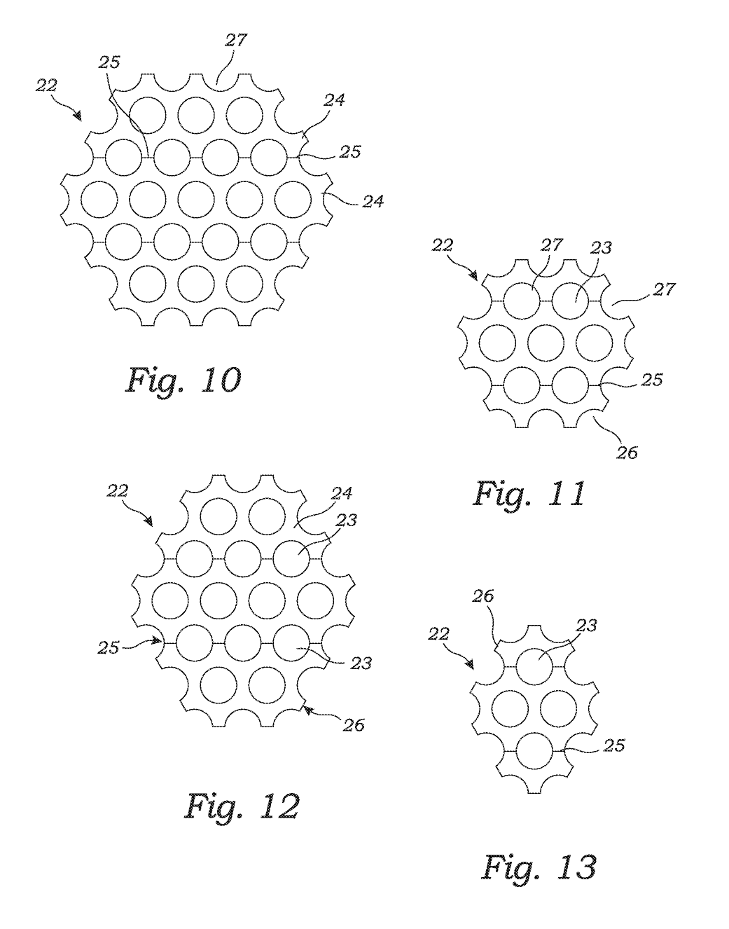

As illustrated in FIGS. 1-19, the sucker rod terminus assembly 10 includes a plurality of generally round strands 20 that are bundled together to form the elongate rod 15. The tensile strength and stiffness of the composite rod assembly 15 is determined by the composite materials used for the individual strands 20, the size of the strands 20, and the number of strands 20 bundled together to make the rod 15. In preferred embodiment, the carbon composite sucker rod strands 20 are manufactured by the pultrusion process or variation thereof wherein high strength fibers are drawn through a resin bath to impregnate the fibers and then through heated dies and ovens to shape, consolidate and cure the strands 20 into generally round rods or similar shapes such as hexagons or octagons. Carbon fiber is the preferred material for the plurality of parallel strands 20, but fiberglass or other high strength fibers may also be utilized so long as they are tailored to meet the strength and stiffness requirements for the sucker rod assembly application.

The polymer matrix within the strands 20 may be epoxy, polyester, vinyl ester, cyanurate ester, benzoxyzene, phenolic or other suitable thermosetting resins. Thermoplastic polymer matrices such as PEI, PEEK, PPS or other suitable polymers may also be used by modifying the pultrusion process to heat, consolidate and shape, and chill the polymer and fiber matrix into usable composite strands. The fiber fraction of the strands 20 should be optimized for tensile strength, stiffness, durability and handling. The ideal size of the strands 20 is roughly from ⅛^{th} inch diameter to 3/16^{th} inch diameter although other sizes may be used, and the ideal size may be dependent on processing and assembly requirements.

Generally, the smaller the diameter of the strands, the faster it can be pultruded because of faster resin curing. A thick pultruded cross section is slow to cure. Additionally, a larger number of strands can be pultruded at the same time when they have a small diameter versus a large diameter. The cross sectional area of typical sucker rods can be pultruded at roughly 10 times the through-put speed when they are made as a plurality of strands versus as a monolithic rod, as such this lowers production cost. Even with the additional steps to cut and bundle the strands, the overall production cost of a carbon fiber composite sucker rod made from a plurality of strands is generally lower than an equivalent monolithic version. However, it is also necessary for the strands to be large enough in cross section for ease of handling and to lay straight in the tooling used for assembly of the sucker rod. Thus, the plurality of the strands 20 that make up the rod 15 should be straight and equal in length in order to maximize the overall strength of the rod 15. Unlike prior manufacturing processes, it is preferred that the strands 20 not be tensioned during assembly as that would be time consuming and costly.

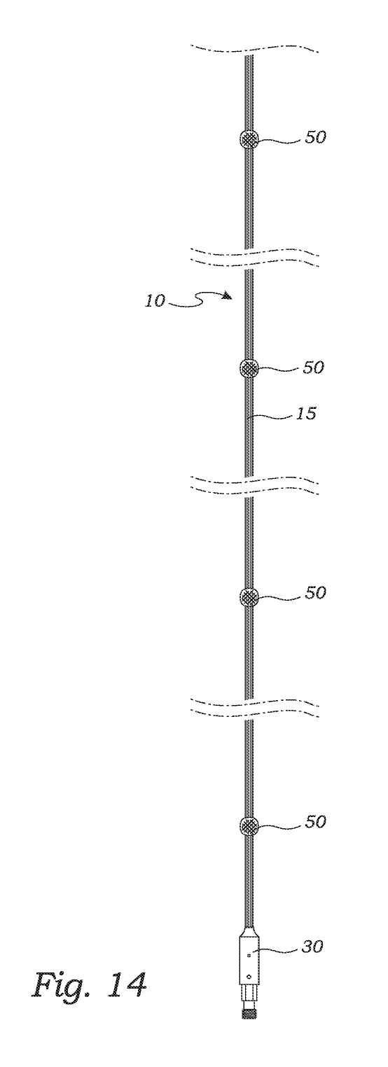

A minimum number of strands 20 are preferably bundled together to form a length of the elongate rod 15. As illustrated in FIG. 14, the bundle of strands 20 is preferably held together with composite wraps 50 spaced incrementally sufficient to hold the bundle of rods together, but allow them to flex between the wrap 50 if the rod experiences a compressive load. The spacing and the length of the incremental composite wraps 50 can be used to tailor the compressive stiffness of the overall carbon composite sucker rod 50. Spacing the composite wraps 50 and/or wear guides at approximately 10-30 times the bundle diameter is believed ideal to provide compressive dampening yet maintain the overall rod sufficiently stiff for handling. Even more preferably, the composite wraps 50 and/or wear guides (described below) are spaced at 15-25 times the bundle diameter, and the preferred distance between wraps or wear guides is approximately 20 times the bundle diameter.

The plurality of parallel strands 20 are preferably bundled in a generally polygonal or round package so the sucker rod assembly 10 can be progressively rotated in a well casing as typically done to prevent wear in one spot. It should be noted that the diameter of the carbon fiber sucker rod assembly 10 is significantly less than its equivalent steel counterpart. For example, the equivalent carbon fiber sucker rod assembly 10 replacing a 1⅛ inch diameter steel sucker rod is just under 1 inch diameter.

The sucker rod assembly's terminus fittings 30 may be affixed at one or both ends of the sucker rod assembly 10. The terminus fittings 30 are preferably made of metal, and more preferably made of a high carbon steel. Other materials including carbon fiber may be employed. However, they are not preferred. Each terminus fitting 30 has a proximal end 31 and a distal end 32. A cavity 33 extends the length of the terminus fitting from its proximal end to its distal end so as to form a proximal opening 35 and a distal opening 36.

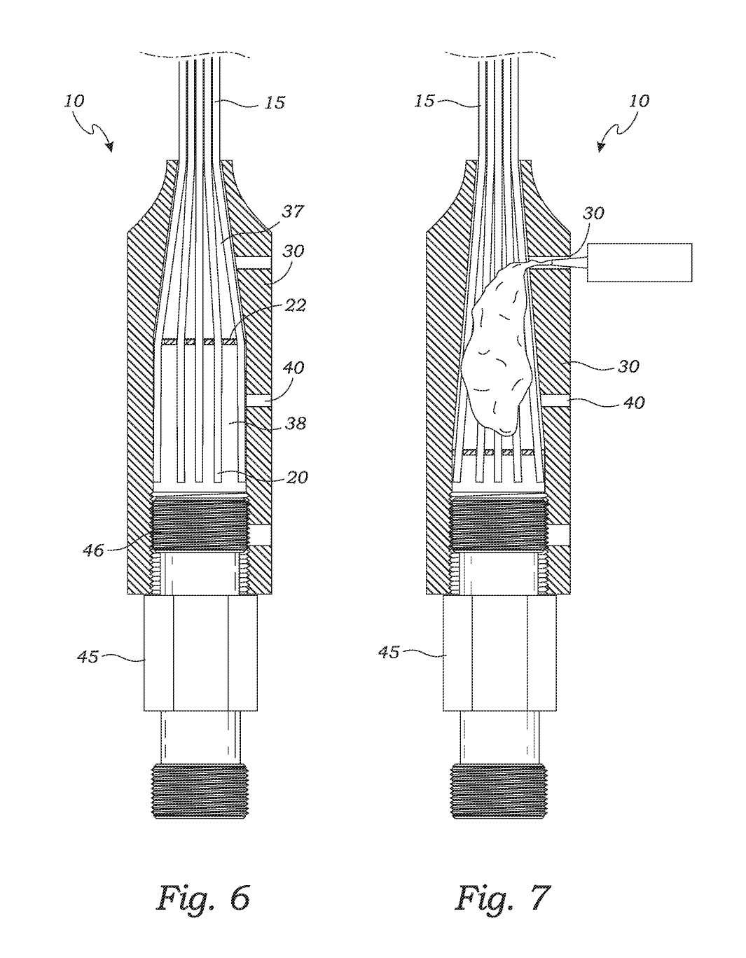

In embodiments illustrated in FIGS. 1-14, the terminus fitting's cavity 33 has a tapered construction so as to have a smaller diameter at its proximal opening 35 than toward its distal end to form a cavity that is conically shaped. In an embodiment illustrated in FIGS. 5 and 6, the central cavity has a conical section 37 towards the terminus fitting's proximal end 31 and a substantially cylindrical section 38 towards the terminus fitting's distal end 32. The cavity's proximal opening 35 is sized to receive one end of the elongate rod 15 and its individual strands 20. Preferably, the cavity's distal opening 36 includes a female thread 41 for affixing to a male threaded member 45.

To lock the strands 20 within the terminus fitting's cavity 33, the strands are splayed out so as to have a diameter at their distal ends greater than the terminus fitting's proximal opening 35. To maintain the strands 20 in a splayed out condition, the sucker rod assembly 10 preferably includes a spreader plate 22 positioned within the terminus fitting's cavity 33. The spreader plate is preferably planar and substantially round so as to define a central axis. In addition, the spreader plate 22 has a plurality of holes 23 for receiving the rod strands 20 so as to splay the strands in a widened orientation compared to where the strands enter the terminus fitting's proximal opening 35. To position the spreader plate within the terminus fitting's central cavity, the spreader plate has a diameter slightly smaller than the diameter fitting's cavity 33 where the spreader plate has been positioned within the cavity 33. Furthermore, preferably the spreader plate's central axis is coincident with the cavity's central axis. As would be understood by those skilled in the art, the diameter of a preferred spreader plate would be smaller when positioned within the cavity's conical section 37 than if the spreader plate 22 were positioned in the cavity's cylindrical section 38.

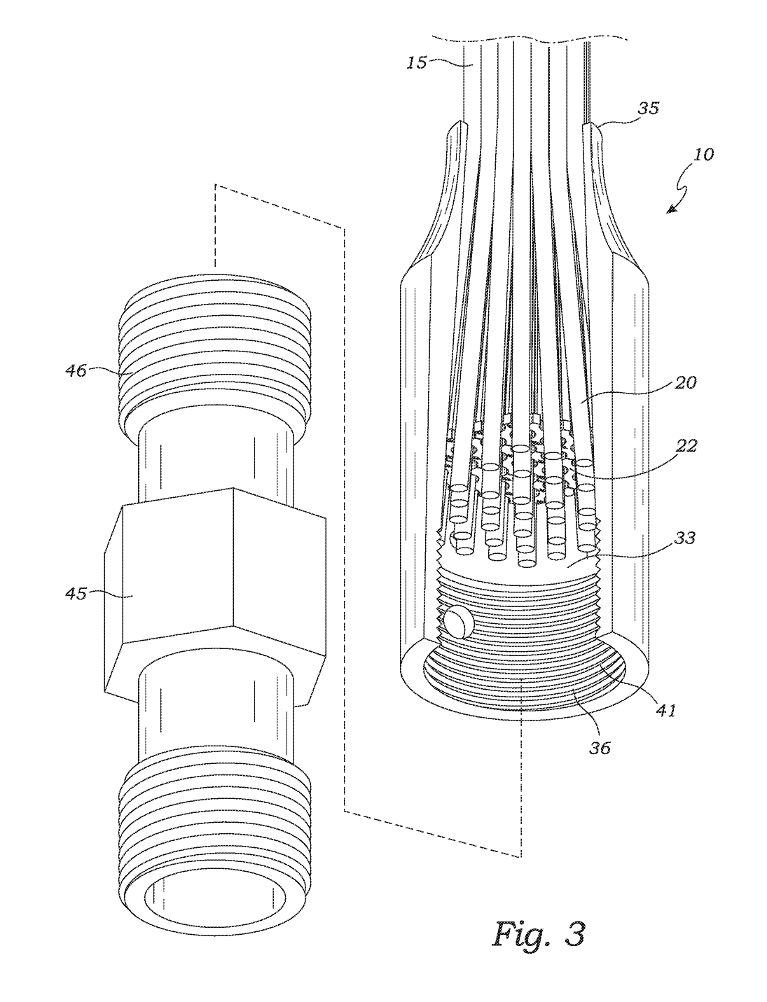

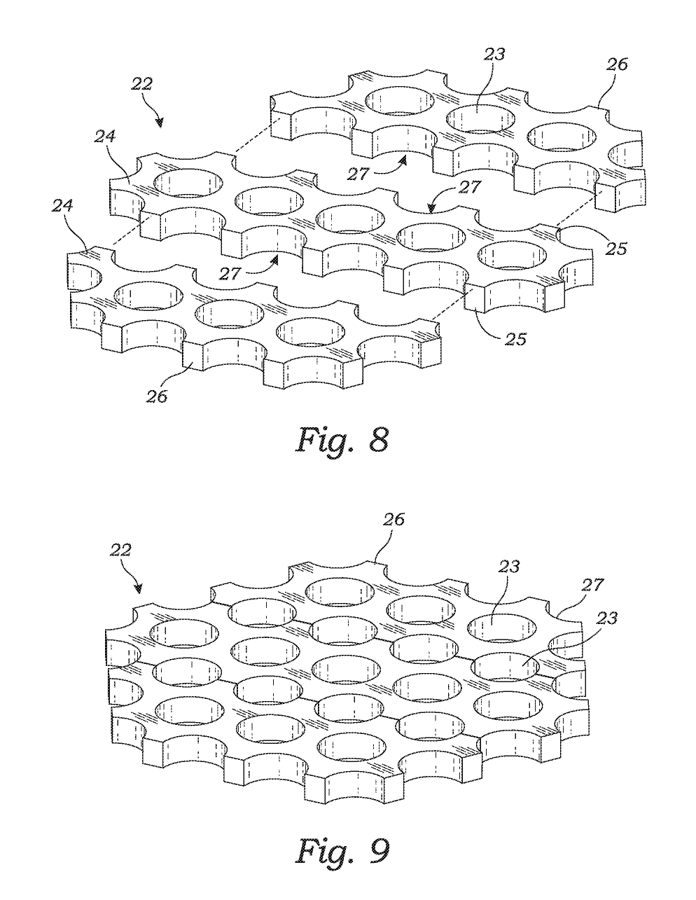

As illustrated in FIGS. 8-13, the preferred spreader plate 22 is constructed of two or more pieces 24 wherein the pieces can be arranged to adjoin one another to form a single spreader plate 22. Each of the spreader plate pieces 24 include an engagement edge 25 where it engages the engagement edge of an adjoining piece 24. Preferably these engagement edges 25 include indents 27 which align and adjoin indents formed in adjoining pieces to form holes 23 for receiving the rod strands 20. Moreover, the spreader plate pieces 24 also include a peripheral edge 26 where the pieces do not engage an adjoining spreader plate piece 24. It is preferred that these peripheral edges also include indents 27 sized for receiving a rod strand 20. As illustrated in FIGS. 2 and 3, strands within the peripheral edge indents are constrained by the terminus fitting's cavity sidewall. The peripheral edge indents 27 also maintain the strands 20 in a widened orientation compared to where the strands pass through the terminus fitting's proximal opening 35. The sucker rod assembly 10 may include any number of spreader plates so as to maintain the strands 20 properly aligned and positioned to prevent withdrawal of the elongate rod 15 from the terminus fitting 30. For example, FIG. 5 illustrates a sucker rod assembly 10 with two spreader plates 22.

In an alternative embodiment not illustrated in the figures, the sucker rod assembly includes a plurality of annular spacers wherein an annular spacer is applied over the ends of each of the strands to maintain the strands in a splayed configuration. For this embodiment, the annular spacers may be positioned longitudinally upon the strands at approximately the same location so that the periphery of each annular spacer engages the periphery of an adjoin spacer. Alternatively, the annular spacers may be longitudinally positioned at different locations so that the periphery of an annular spacer engages adjoining strands.

As illustrated in FIGS. 5 and 6, the terminus fitting's tapered cavity 33 may include a conical section 37 and a cylindrical section 38. If it is desirable to minimize the size of the terminus fitting 30, the cavity's conical section 37 can be shorter in length provided the overall cavity length is retained. More specifically, shortening the length of the conical section 37 while retaining the overall length of the cavity 33 enables one to maintain the wedge effect of affixing the rod 15 to the terminus fitting 30 and thus maintain the overall adhesive shear strength of the wedge 21 to the rod 15 when the size of the fitting is constrained. For example, FIG. 7 illustrates a terminus fitting where the conical portion 37 is shorter than the cylindrical portion 38. Conversely, FIG. 6 illustrates a terminus fitting where the conical portion 37 is longer than the conical portion illustrated in FIG. 5.

The terminus fitting's cavity 30 (as illustrated in FIG. 7) is preferably injected or filled with a polymer material that adheres to the strands 20 and forms a mechanical tapered wedge 21 within the terminus fitting 30. The polymer material for the wedge 21 can be epoxy, phenolic or other thermosetting resin meeting the performance requirements. For extremely deep wells, a heat resistant ceramic material may be used within the terminus cone. In contrast to traditional potted steel wire rope terminations where resin or molten metal is poured into the open end of the terminus, the preferred method for assembling the carbon fiber sucker rod 10 is to inject the polymer or ceramic resin material directly into the terminus fitting 30. Preferably, an injection port 39 and vent port 40 are used for the resin material injection. The injection port 39 is provided to inject the polymer or ceramic resin into the fitting 30. The vent port provides a temporary vent and a sight window to show that adhesive has filled the cavity 30. Preferably, the polymer or ceramic material is injected into the injection port 39 while the terminus fitting 30 is lying in a horizontal position. It is important to assemble the composite sucker rod 10 in a horizontal position with the plurality of strands 20 supported substantially straight and in the desired bundle configuration with the terminus end fittings 30 properly aligned before the resin material is injected into the terminus fitting's injection port 39. It is also important for the splayed orientation of the strands 20 to be configured properly and consistent.

As illustrated in FIGS. 3-7, in a preferred embodiment, the sucker rod assembly 10 includes a threaded connection member 45 to interface with a standard sucker rod coupling that connects rod to rod to form a sucker rod string. In another embodiment, the threaded connection member 45 can be applied on only one end of the sucker rod 10 and no threaded connection member is affixed to the other end. This enables one sucker rod 10 to be coupled to another without the use of traditional sucker rod couplings. Instead, the connection member 45 of one sucker rod assembly 10 threads into the female threaded opening 36 of the other sucker rod assembly 10.

Further, in a preferred embodiment, it is desirable to compress the hardened resin wedge 21 with the male threaded portion of the connection member 45 as a means to firmly hold the wedge 21 in position within the terminus fitting 30, especially when it is anticipated that the sucker rod assembly will experience compressive loads. The preferred method to compress the wedge 21 within the terminus 30 is to inject the polymer or ceramic resin into the terminus 30 with the threaded connection member 45 backed out slightly, for example, approximately ⅛ to ½ turn, from its final position or not fully torqued. As a result, the wedge 21 will be in-situ molded within the terminus 30. After the wedge 21 is cured, the threaded connection member 45 is fully screwed in place and torqued as appropriate. This method results in putting a pre-load on the wedge 21 which enhances its ability to handle cyclic tension and compressive loads. Another option is to use a dummy connection member (not shown) when the polymer or ceramic wedge is injected into the fitting 30. This dummy connection member can be slightly shorter than the final connection member 45 so a compressive load is applied to the wedge 21 when the final connection member 45 is installed.

As illustrated in FIG. 14, wear guides 50 and/or paraffin scrapers may be installed along the length of the sucker rod terminus assembly 10. Wear guides 50 are typically used only on sucker rods running in a deviated portion of the oil well. Traditional wear guides are made from a thermoplastic polymer and are pre-molded and snapped in place or injection molded directly onto the steel sucker rod. Traditional wear guides often do not stay in place during operation.

For a preferred sucker rod 10, a fiber filled composite wear guide 50 is molded directly onto the bundle of strands 20. This can be accomplished by infusion molding a relatively thick three dimensional fiber mat that is wrapped around the strands bundle. In a preferred example, the fiber form is a wear resistant spun polyester mat made by 3M that is from ¼ to ⅜ inch thickness. In one example, a 3-4 inch wide by 9-12 inch long strip of ¼ inch thick spun polyester mat is wrapped around the plurality of strands 20 of the sucker rod assembly 10 at the location desired for the wear guide 50. A two piece mold is clamped around the wrapped fiber form. Thermosetting epoxy is injected into the mold through an injection port to flow through the porous spun polyester material. When cured, the mold is removed. The three dimensional spun polyester mat impregnated with epoxy forms a wear resistant composite particularly suited for application that is permanently bonded over the sucker rod assembly 10. Advantageously, as illustrated in FIG. 14, the wear guides 50 can also function as wraps incrementally spaced to provide the desired compressive dampening and rod stiffness, as described above. In another embodiment, woven fiberglass, carbon fiber or aramid fiber cloth tape can be convolutely wrapped with resin around the bundle of carbon fiber rods such that it functions both as a wear guide and the banding that holds the plurality of rods together.

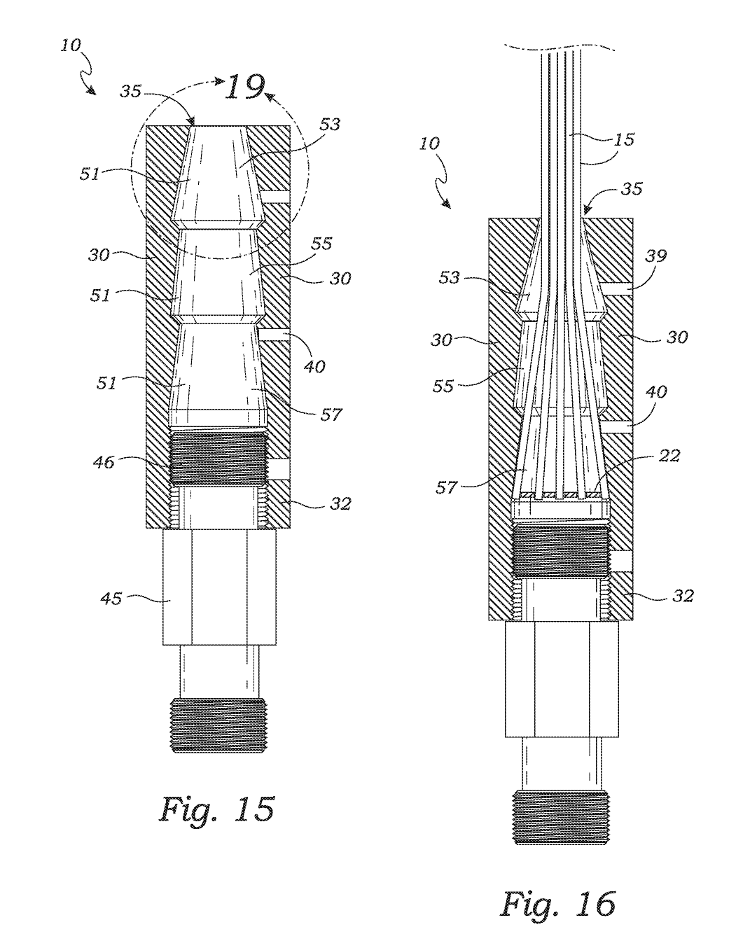

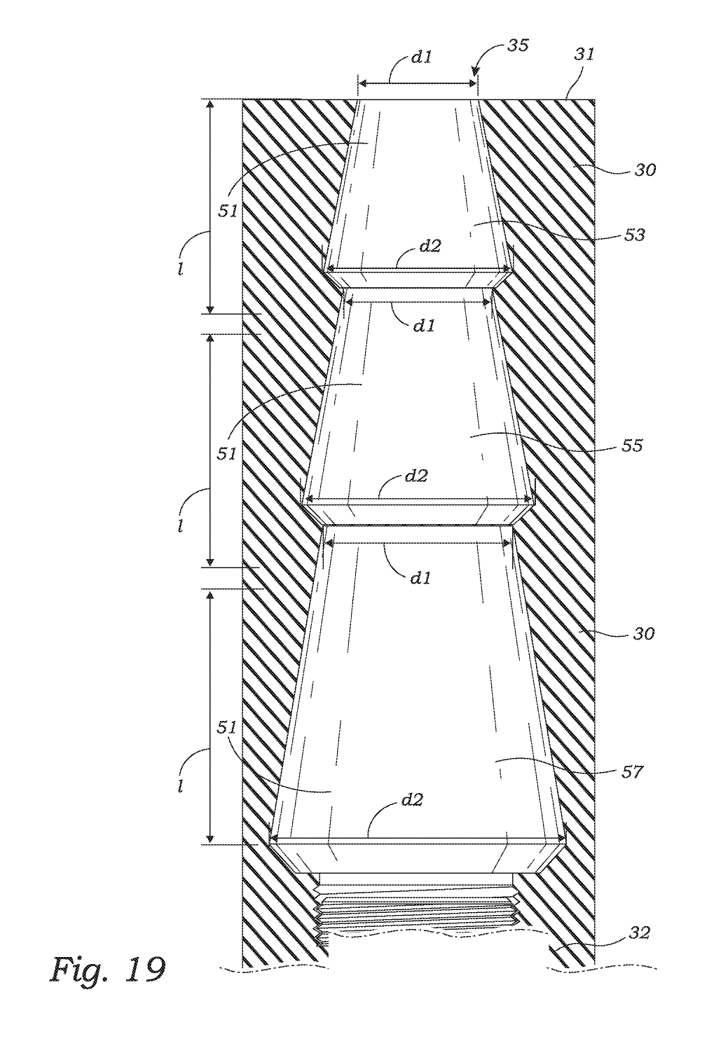

As illustrated in FIGS. 15-19, in additional preferred embodiments, the terminus fitting's central cavity 33 includes a plurality of chambers 51 wherein each chamber is frustum shaped so as to have a proximal end having a small diameter “d1”, a distal end having a large diameter “d2”, and a length “1” between the proximal end and distal end. As illustrated in FIG. 19, it is preferred that frustum shaped chambers have different shapes and/or sizes wherein at least a frustum chamber's proximal end diameter, distal end diameter, or length is different than an adjacent frustum chamber's proximal end diameter, distal end diameter, or length. Even more preferably, each frustum chamber is diametrically larger than the frustum chamber positioned proximally to it. For example, for a three frustum chambered terminus fitting illustrated in FIGS. 15-19, it is preferred that the central frustum chamber 53 have diameters d1 and d2 which are larger than proximal frustum chamber 51, and that the distal frustum chamber 55 have diameters d1 and d2 which are larger than the central frustum chamber 53.

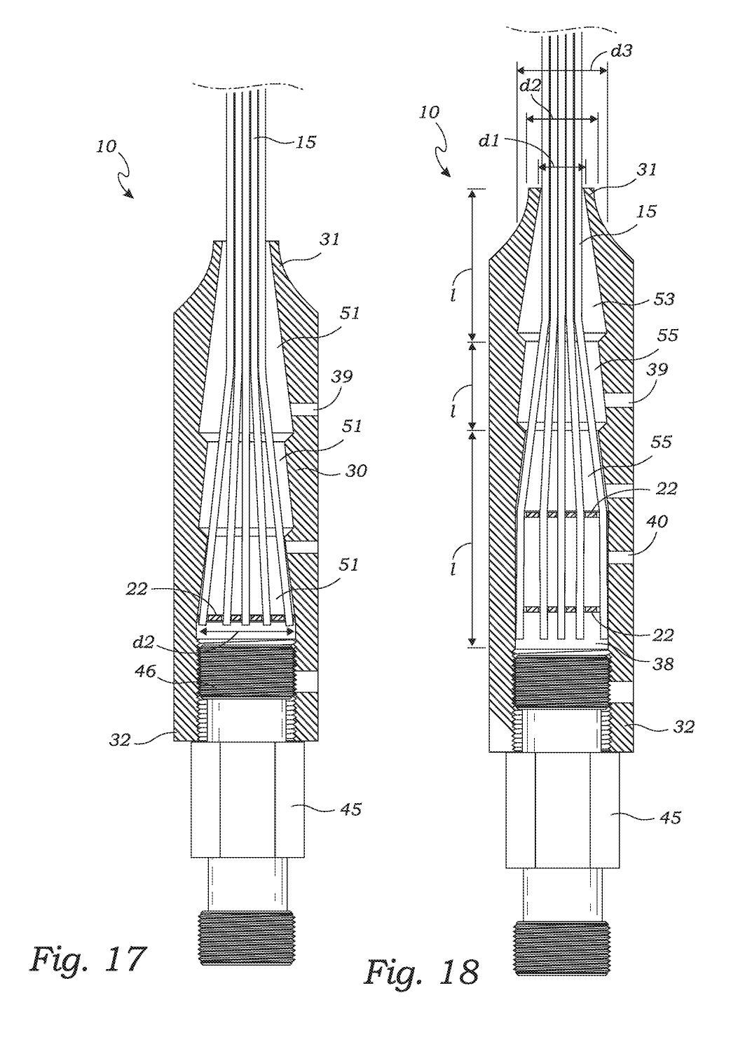

The terminus fitting 30 may be constructed in innumerable shapes and sizes as can be determined by those skilled in the art. For example, as illustrated in FIGS. 17 and 18, the terminus fitting's exterior proximal end 31 may be tapered. In addition, as illustrated in FIGS. 17 and 18, the terminus fitting's cavity 33 may include a cylindrical section 38 towards the terminus fitting's distal end 32.

As with embodiments described above, the rod strands 20 are positioned within the terminus fitting's central cavity 33 and the strands are splayed out so as to have a diameter at their distal ends greater than the terminus fitting's proximal opening 35. Preferably, the sucker rod assembly 10 includes one or more spreader plates 22 positioned within the terminus fitting's cavity 33. The spreader plates may be a one-piece construction. However preferably, the sucker rod assembly embodiments illustrated in FIGS. 15-19, include one or more spreader plates 22 constructed of two or more pieces 24 wherein the pieces can be arranged to adjoin one another to form a single spreader plate 22 as illustrated in FIGS. 8-13.

As with previous embodiments, the terminus fitting's cavity 30 is preferably injected or filled with a polymer material that adheres to the strands 20. The polymer material for the wedge 21 can be epoxy, phenolic or other thermosetting resin meeting the performance requirements. This terminus fitting construction having a plurality of frustum shaped chambers creates a resin wedge also having a double or triple (or even more) frustum wedge construction.

The sucker rod's terminus fitting 30 and resin wedge 21 with multiple frustum chambers 51 embodiment is not intended to be limited to two or three frustums as illustrated in FIGS. 15-19. Instead, the terminus fitting 30 and resin wedge may have four or more frustum chambers each preferably having a radius/diameter that is progressively larger from the proximal end to the distal end of the terminus fitting. However, in the preferred embodiment illustrated in FIGS. 15-19, the terminus fitting 30 and wedge 21 are constructed with three frustums chambers 51 with each frustum chamber progressively larger than the proximally adjacent frustum chamber.

Creating a multiple frustum shaped wedge in the metal terminus end fitting reduces the effect of the localized stress concentration at the nose of the terminus. The bulk modulus of the frustum is different at the terminus' proximal end 31 versus its distal end 32. At the proximal end 31, the wedge is made up of mostly strands 20 since the strands enter the fitting tightly grouped together. Hence, the bulk modulus at the proximal end of the wedge is predominately that of the composite strands. However, at the larger distal end of the wedge, the bulk modulus is comprised of a more equal ratio of strands and wedge polymer material. As a result, the bulk modulus at the large end of the frustum is significantly lower than at the small end of the frustum. In fact, the bulk modulus at the large end of the frustum is equal to the frustum polymer itself much like the spring constant of a series of springs with two different stiffness springs is equal to only the softer spring. Thus, there is often a 5:1 difference in the bulk modulus of the frustum at the small end versus the large end. Hence, there is not the same cushioning effect against a stress concentration for the strands at the nose of the frustum as there is at the large end of the frustum where the strands are surrounded with and spread within a lower modulus polymer. Additionally, the nose is more susceptible to compressing due to the wedge effect, thereby allowing axial displacement of the frustum. These conditions make the composite strands especially susceptible to a tri-axial stress concentration at the nose of the terminus fitting as the tensile load is increased. However, by including second and third frustum chambers 51 filled with polymer resin, as shown in FIGS. 15-19, the wedge construction provides a cushioning effect which reduces the stress concentration at the nose and allows for the stress to be spread over a greater percentage of the wedge and minimizes axial displacement of the wedge under tensile loads. Moreover, by altering the shapes and/or sizes of the frustum chambers, one is able to equalize the bulk modulus of the wedge throughout the terminus fitting's cavity.

Though not shown in FIGS. 15-19, the bundle of strands can be wrapped with a band of fiber composite material at the proximal end of the wedge in the proximal frustum. The band of hoop fibers reinforces the proximal frustum and helps to reduce the radial stress imposed by axial displacement of the frustum which works in conjunction with the softening effects of the double conical wedge.

While several particular forms of the invention have been illustrated and described, it will be apparent that various modifications can be made without departing from the spirit and scope of the invention. Therefore, it is not intended that the invention be limited except by the following claims. Having described my invention in such terms so as to enable person skilled in the art to understand the invention, recreate the invention and practice it, and having presently identified the presently preferred embodiments thereof we claim:

1. A sucker rod terminus assembly for underground wells comprising:
a plurality of strands forming an elongate rod having first and second ends;
a terminus fitting having a proximal end and a distal end and extending longitudinally to form a central axis, said terminus fitting having a central cavity coaxial to said terminus fitting's central axis, said central cavity extending to said terminus fitting's proximal end to form a proximal opening receiving said elongate rod within said cavity, said cavity including at least two frustum shaped chambers coaxially aligned with said cavity's central axis, wherein each of said frustum shaped chambers has a circular proximal end, a circular distal end, a length as measured from their proximal end to their distal end, and an axis coaxial to said central axis, said frustum shaped chambers distal ends having a diameter greater than the diameter of their proximal ends; and
a hardened material within said cavity, said hardened material adhered to said strands and maintaining said strands in a splayed out condition in a widened orientation toward the terminus' distal end compared to where the strands pass through said terminus fitting's proximal opening so as to form an at least two frustum shaped plug which prevents said rod from withdrawing from said terminus fitting's proximal opening.

2. The sucker rod terminus assembly for underground wells of claim 1 wherein said at least two frustum shaped chambers include a first frustum shaped chamber and a second frustum shaped chamber, and the first and second frustum shaped chambers having different shapes wherein at least one of said first chamber's proximal end diameter, distal end diameter, or length is different than said second chamber's proximal end diameter, distal end diameter, or length.

3. The sucker rod terminus assembly for underground wells of claim 1 wherein said at least two frustum shaped chambers include a first frustum shaped chamber positioned proximally to a second frustum shaped chamber, and first frustum's proximal end diameter and distal end diameter are smaller that said length being different than the distal frustum's proximal end diameter, distal end diameter, or length.

4. The sucker rod terminus assembly for underground wells of claim 1 further comprising a first spreader plate positioned within said cavity, said first spreader plate having a plurality of holes receiving said plurality of strands so as to splay out said strands in a widened orientation toward the terminus' distal end compared to where the strands pass through said terminus fitting's proximal opening.
